(19) United States
(12) Patent Application Publication
(10) Pub. No.: US 2013/0271790 A1
(43) Pub. Date: Oct. 17, 2013

(54) Imaging Module Unit for Copier

(71) Applicant: Minoru Amishima, Tokyo (JP)

(72) Inventor: Minoru Amishima, Tokyo (JP)

(73) Assignee: Shinten Sangyo Co., Ltd., Tokyo (JP)

(21) Appl. No.: 13/493,995

(22) Filed: Jun. 11, 2012

(30) Foreign Application Priority Data
Apr. 14, 2012 (JP) JP-2012-2661-U

(51) Int. Cl. G06F 15/00

(52) U.S. Cl. 358/1.18

(57) ABSTRACT

An imaging module unit fixedly mounted on top of a copier within a document contact area where a document contacts a top surface of the copier. The imaging module unit has a digital signal processor (DSP) chip mounted a base plate, an imaging module mounted on the base plate, and a light-emitting diode mounted on the base plate. The imaging module unit directs light from the LED onto the document, images the contents of the document with the imaging module, and, through the DSP chip, automatically adjusts output.

### CROSS-REFERENCE TO RELATED APPLICATION

This patent application is based on and claims priority pursuant to 35 U.S.C. §119 from Japanese Utility Model Application No. 2012-2661, filed on Apr. 14, 2012, which is hereby incorporated by reference herein in its entirety.

### BACKGROUND OF THE INVENTION

1. Field of the Invention

The present invention relates to an imaging module unit for a copier, and more particularly, to a specialized imaging module unit designed to upgrade the performance of a copier.

2. Description of the Related Art

The document size sensors currently in use with copy machines (hereinafter “copiers”) identify the size of a document automatically using a plurality of infrared light-emitting diodes (LEDs) and infrared sensors. But there is room for improvement in their operation.

In particular, there is a need for a high-performance copier with a variety of capabilities that are delivered using an imaging module unit specifically adapted to a copier, including automatic document size identification, document lightness/darkness identification, front/back side identification, document position identification, document preview, and text insertion capabilities.

### SUMMARY OF THE INVENTION

The present invention provides a novel imaging module unit fixedly mounted on top of a copier within a document contact area where a document contacts a top surface of the copier. The imaging module unit includes a digital signal processor (DSP) chip mounted a base plate, an imaging module mounted on the base plate, and a light-emitting diode mounted on the base plate. The imaging module unit directs light from the LED onto the document, images the contents of the document with the imaging module, and, through the DSP chip, automatically adjusts output.

The imaging module unit may further include a wide-angle lens. Additionally, the imaging module unit may further include an imaging element mounted on an inner surface of the base plate and a lens holder having a conical concavity and affixed to the base plate by reflow soldering. The wide-angle lens is fitted into a lens fitting portion of a barrel having a conical projecting portion that fits the conical concavity of the lens holder.

Additionally, a conical outer circumferential surface of a proximal end portion of the lens fitting portion is fitted into the inner circumferential surface of the conical concavity of the lens holder, to restrict axial movement of the wide-angle lens.

Additionally, the wide-angle lens has a flange one face of which is directly seated on and supported by the lens holder to align the wide-angle lens with the imaging element.

Additionally, the barrel, in which the wide-angle lens and the lens fitting portion are formed as a single integrated unit, is snapped onto a top portion of the lens holder to ensure that the barrel is fixedly mounted in place.

With the imaging module unit for copier having the configuration described above, an ordinary copier can be upgraded so as to be able to identify the size, position, color, and lightness/darkness of text of a document automatically.

### BRIEF DESCRIPTION OF THE SEVERAL VIEWS OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1 is a perspective view of an imaging module unit for copier according to embodiments of the present invention;

FIG. 2 is an enlarged vertical sectional view of the imaging module unit shown in FIG. 1;

FIG. 3 is a partial perspective view of a copier mounting the imaging module unit for copier; and

FIG. 4 is a partial sectional view of a copier mounting the imaging module unit for copier.

### DETAILED DESCRIPTION OF THE INVENTION

A description will now be given of preferred embodiments of the present invention. In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

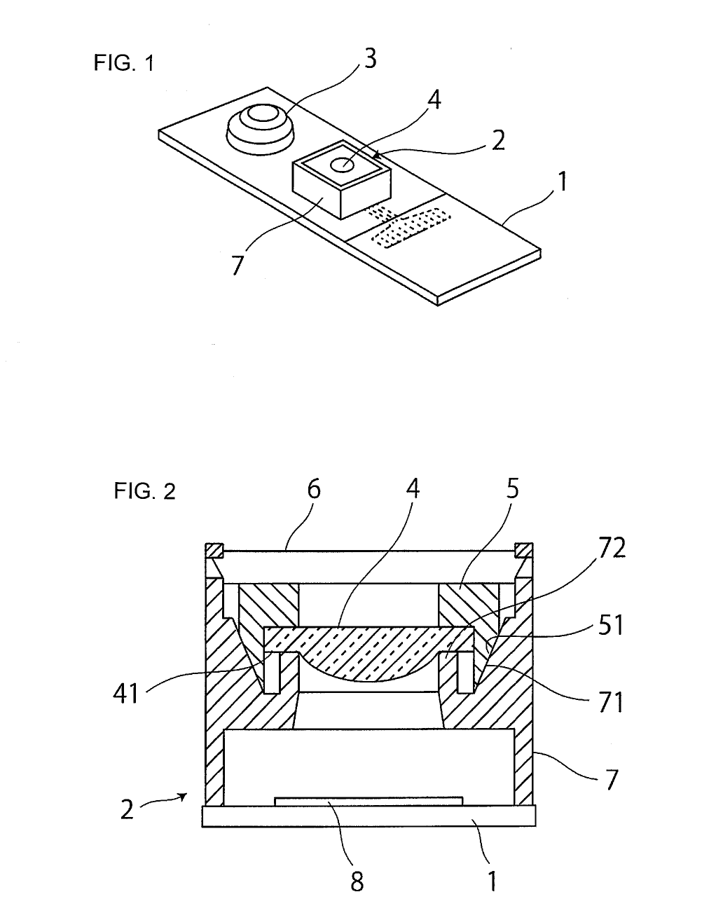

With initial reference to FIGS. 1, 3, and 4, a description will now be given of an imaging module unit for copier according to embodiments of the present invention.

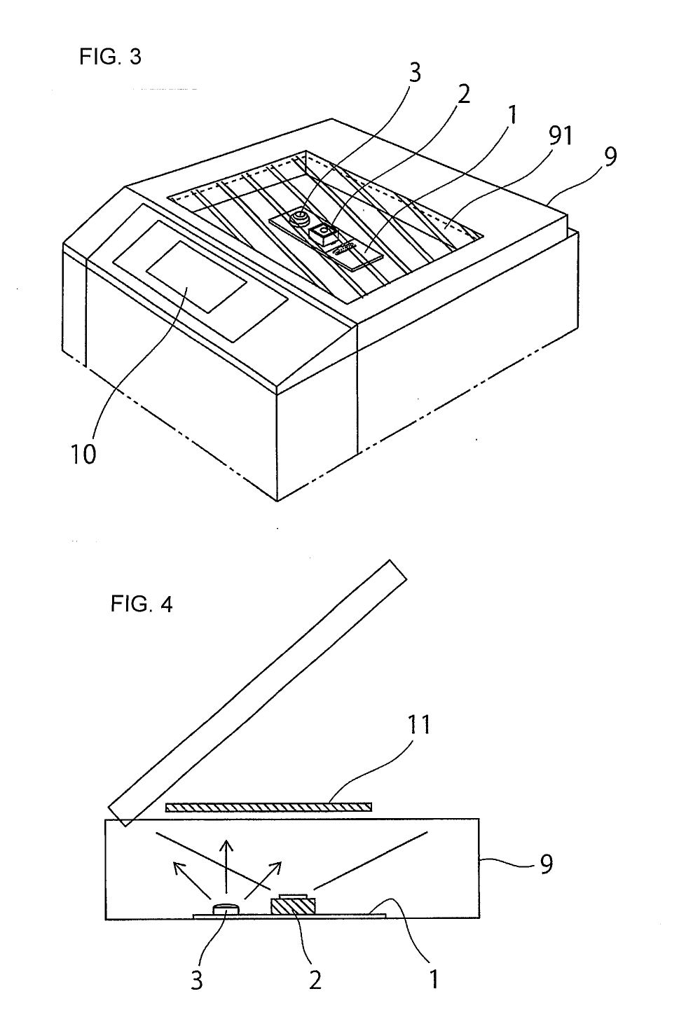

The imaging module unit is constructed of a base plate 1 mounting a digital signal processor (DSP) chip. On the base plate 1 is mounted an imaging module 2 and a light-emitting diode (LED) 3. As shown in FIGS. 3 and 4, the imaging module unit is fixedly mounted on top of the copier where a document 11 contacts the surface of the copier. The imaging module unit directs light from the LED 3 onto the document 11, images the contents of the document 11 with the imaging module 2, and, through the DSP chip, automatically adjusts the output.

Optionally, a wide-angle lens 4 may be provided to the imaging module 2. By imaging the document 11 contents with the wide-angle lens 4, the size, position, color, and lightness/darkness of text of the document 11 are imaged and the output is automatically adjusted through the DSP chip. Through a control panel 10, a real-time preview of the document 11 can be implemented to allow a copy of the document 11 to be previewed and to enable text to be inserted, moved, and removed.

A detailed description will now be given of the imaging module 2.

As shown in FIG. 2, an imaging element 8 is mounted to an inner surface of the base plate 1 and a lens holder 7 having a conical concavity 71 is affixed to the imaging module 2 by reflow soldering. The wide-angle lens 4 is fitted into a lens fitting portion 5 of a barrel 6 having a conical projecting portion 51 that fits the conical concavity 71 of the lens holder 7.

The conical outer circumferential surface of the proximal end portion of the lens fitting portion 5 is fitted into the inner circumferential surface of the conical concavity 71 of the lens holder 7, thereby regulating the coaxiality of the installed wide-angle lens 4.

One face of a flange 41 of the wide-angle lens 4 is directly seated on and supported by the lens holder 7, thereby regulating the parallelity of the installed wide-angle lens 4 and aligning it with the imaging element 8.

The barrel 6, in which the wide-angle lens 4 and the lens fitting portion 5 are formed as a single integrated unit, is snapped onto the top of the lens holder 7 to ensure that the barrel 6 is fixedly mounted in place.

Additionally, as shown in FIGS. 3 and 4, the imaging module unit constructed of a base plate 1 mounting a digital signal processor (DSP) chip, and on which base plate 1 is mounted an imaging module 2 and a light-emitting diode (LED) 3, is in turn fixedly mounted on top of the copier where a document 11 contacts the surface of the copier. The imaging module unit directs light from the LED 3 onto the document 11, images the contents of the document 11 with the imaging module 2, and, through the DSP chip, enables a real-time preview.

With the imaging module unit configured as described above, a real-time preview of the document 11 can be displayed on a control panel 10 of the copier and characteristics of the final output copy adjusted as necessary. More specifically, by imaging the document 11 contents with the wide-angle lens 4, the size of the document 11, its position, color, and lightness/darkness of text of the document 11 are imaged and the output can be automatically adjusted through the DSP chip.

In addition, using the control panel 10, the user is able to obtain the position of the document or documents 11 on the copier. By checking the document 11 positioning screen shown in FIG. 6, protrusion of the document 11, overlap of successive documents 11, and/or inadvertent rotation of the document 11 can be corrected.

Moreover, text can be inserted and document 11 copies can be marked “confidential”, etc.; a portion of the document 11 can be extracted and copied; and output can be automatically adjusted.

As described above, the present invention upgrades the performance of a conventional copier with a single specialized module, thereby providing an ordinary copier with new capabilities such as document size identification, etc.

As can be appreciated by those skilled in the art, numerous additional modifications and variations of the present invention are possible in light of the above teachings. It is therefore to be understood that, within the scope of the appended claims, the present invention may be practiced otherwise than as specifically described herein.

What is claimed is:

1. An imaging module unit fixedly mounted on top of a copier within a document contact area where a document contacts a top surface of the copier, the imaging module unit comprising:
a digital signal processor (DSP) chip mounted a base plate;
an imaging module mounted on the base plate; and
a light-emitting diode mounted on the base plate,
wherein the imaging module unit directs light from the LED onto the document, images the contents of the document with the imaging module, and, through the DSP chip, automatically adjusts output.

2. The imaging module unit according to claim 1, further comprising a wide-angle lens,
wherein, by imaging the document with the wide-angle lens, a size, position, color, and lightness/darkness of text of the document are imaged and the output is automatically adjusted through the DSP chip, and
a real-time preview of the document can be implemented to allow a copy of the document to be previewed and to enable text to be inserted, moved, and removed.

3. The imaging module unit according to claim 2, further comprising:
an imaging element mounted on an inner surface of the base plate; and
a lens holder having a conical concavity and affixed to the base plate by reflow soldering;
wherein the wide-angle lens is fitted into a lens fitting portion of a barrel having a conical projecting portion that fits the conical concavity of the lens holder.

4. The imaging module unit according to claim 3, wherein a conical outer circumferential surface of a proximal end portion of the lens fitting portion is fitted into the inner circumferential surface of the conical concavity of the lens holder, to restrict axial movement of the wide-angle lens.

5. The imaging module unit according to claim 3, wherein the wide-angle lens has a flange one face of which is directly seated on and supported by the lens holder to align the wide-angle lens with the imaging element.

6. The imaging module unit according to claim 3, wherein the barrel, in which the wide-angle lens and the lens fitting portion are formed as a single integrated unit, is snapped onto a top portion of the lens holder to ensure that the barrel is fixedly mounted in place.
